(19) United States
(12) Patent Application Publication
(10) Pub. No.: US 2006/0147192 A1
(43) Pub. Date: Jul. 6, 2006

(54) Best shooting moment selectable digital camera apparatus

(75) Inventors: Jian Zhang, Hangzhou (CN); Wende Li, Hangzhou (CN); Jianqiang Huang, Hangzhou (CN)

Correspondence Address: BROMBERG & SUNSTEIN LLP, 125 SUMMER STREET, BOSTON, MA, 02110-1618, US

(73) Assignee: Jian Zhang

(21) Appl. No.: 11/228,081

(22) Filed: Sep. 16, 2005

(30) Foreign Application Priority Data
Jan. 5, 2005 (CN) 200510023256.5

(51) Int. Cl. G03B 17/00

(52) U.S. Cl. 396/263

(57) ABSTRACT

The present invention relates to a best shooting moment selectable digital camera apparatus. This digital camera apparatus could decide the instantaneous best shooting moment to take photos. The technical scheme is: including camera head, memory circuit and signal processor, the signal processor includes the co-series face detecting module, eye & mouth positioning module and blink judging & mouth open judging module, meanwhile, the face detecting module reads out the digital image from memory circuit and delivers the result into eye & mouth positioning module after face positioning, the eye & mouth positioning module delivers the result into blink judging & mouth open judging module after eye and mouth positioning, the blink judging & mouth open judging module sends out the judgment result; the controlling circuit issues a shoot controlling order when the judgment result of the said blink judging & mouth open judging module means a best shooting moment.

This application claims priority from Chinese patent application 200510023256.5, filed on Jan. 5, 2005, the contents of which are incorporated herein by reference.

### FIELD OF THE INVENTION

The present invention relates to a best shooting moment selectable digital camera apparatus, especially relates to a digital camera apparatus that could obtain the person's face state to decide shooting moment. It is suitable for professional and amateur shutterbugs or ordinary users.

### BACKGROUND OF THE INVENTION

The current typical digital camera apparatus has no function of allowing operator to select the best shooting moment. The typical digital camera apparatus has function of allowing operator to review the taken images after photo taking. For example, the user displays the taken images on the display device after photo taking. For numerous taken images especially the more person's images, however, the photos quality is hard to be ensured owing to the instantaneous blinking or mood changing of shot person. The traditional digital camera apparatus couldn't distinguish the shooting moment, couldn't distinguish if the person is being blinking and if the person is wearing a cheerful expression, it thus brings about a tremendous difficulty of shooting moment selection to operator and results in a poor photos quality.

### CONTENTS OF THE INVENTION

The present invention is proposed to resolve the above problems to provide a best shooting moment selectable digital camera apparatus. This digital camera apparatus has the typical digital camera apparatus's functions not only, but also could decide the instantaneous best shooting moment to take image.

The technical scheme of the present invention is: A best shooting moment selectable digital camera apparatus, comprising a camera head and a memory circuit, characterized in that: the camera apparatus further includes:

Signal processor, including co-series face detecting module, eye & mouth positioning module and blink judging & mouth open judging module, in which:

The face detecting module reads out the digital image from memory circuit and delivers the result into eye & mouth positioning module after face positioning;

The eye & mouth positioning module delivers the result into blink judging & mouth open judging module after eye and mouth positioning;

The blink judging & mouth open judging module sends out the judgment result;

The controlling circuit issues a shoot controlling order when the judgment result of the said blink judging & mouth open judging module means a best shooting moment, and doesn't issue a shoot controlling order if the judgment result doesn't mean a best shooting moment.

The said face detecting module includes the multi-dimensioned template, awaiting-taken image and template matching arithmetic unit, the template matching arithmetic unit receives the multi-dimensioned template and awaiting-taken image in memory, and delivers the arithmetic result into the face image position, the said multi-dimensioned template, awaiting-taken image and face image position are stored at the various address of the memory respectively.

The said eye & mouth positioning module includes the awaiting-taken image, face image position and horizontal projecting & vertical projecting unit, the horizontal projecting & vertical projecting unit receives the awaiting-taken image and face image position in memory, and delivers the arithmetic result into the eye & mouth position, the said awaiting-taken image, face image position and eye & mouth position are stored at the various address of the memory respectively.

The said blink judging & mouth open judging module includes the awaiting-taken image, eye & mouth position and blink judging & mouth open judging unit, the blink judging & mouth open judging unit receives the awaiting-taken image and eye & mouth position in memory, obtains the blink judging & mouth open judging results for each person's face and issues the order to the controlling circuit, the said awaiting-taken image and eye & mouth position are stored at the various address of the memory respectively.

The beneficial effects of the present invention is: At time of photo taking, it could conveniently distinguish each person's face expression, such as, if the eyes are opened and if the person is wearing a cheerful expression, so as to select a best photo taking moment and thus improve greatly the photo taking quality.

### BRIEF DESCIPTION OF THE APPENDED DRAWINGS

FIG. 1 is a system block diagram showing the structure of the present invention.

FIG. 2 is a structure block diagram showing the signal processor in FIG. 1.

FIG. 3 is a structure block diagram showing the face detecting module in FIG. 2.

FIG. 4 is a structure block diagram showing the eye & mouth positioning module in FIG. 2.

FIG. 5 is a structure block diagram showing the blink judging & mouth open judging module in FIG. 2.

FIG. 6 is a principle block diagram showing the eye & mouth positioning module and blink judging & mouth open judging module.

FIG. 7 is a principle block diagram against the mouth open judging in the blink judging & mouth open judging module.

FIG. 8 is a flow chart showing the template matching in the present invention.

FIG. 9 is a flow chart showing the blink judging & mouth open judging module in the present invention.

FIG. 10 is a flow chart showing the signal processor in the present invention.

### DESCRIPTION OF THE EMBODIMENTS

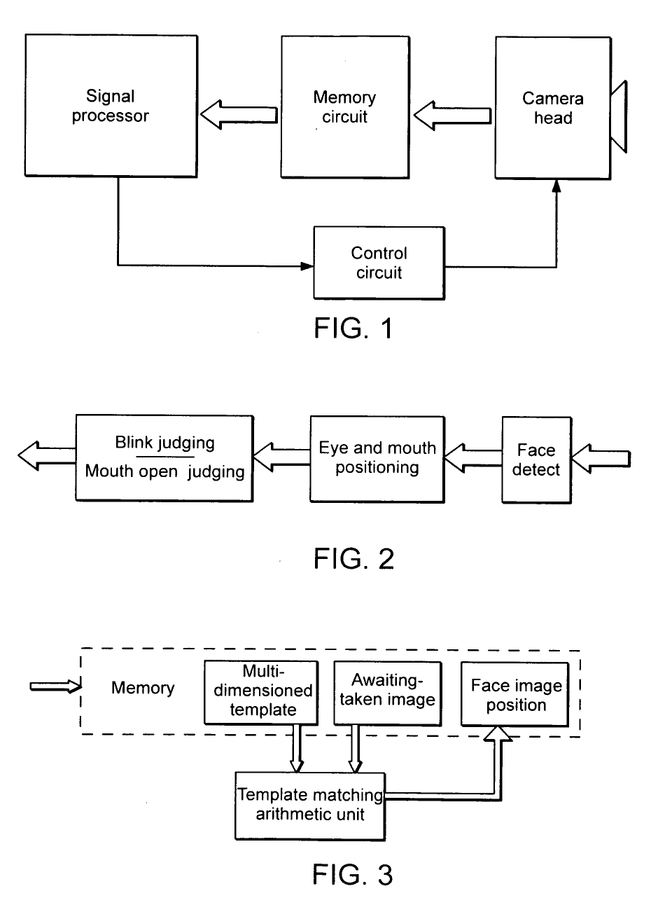

As FIG. 1 shows, the preferred embodiment includes a camera head 1, memory circuit 2, signal processor 3 and controlling circuit 4, the camera head 1 stores the signals obtained and digitalized into the memory circuit 2, the signal processor 3 processes the digital images stored in the memory circuit 2, judges that if the person in the digital image is blinking and if the person is wearing a cheerful expression, and decides if this is the best shooting moment, in case of deciding that this is the best shooting moment, the signal processor 3 would issue a shoot controlling order via the controlling circuit 4.

As FIG. 2 shows, the signal processor 3 includes a co-series face detecting module 3-1, eye & mouth positioning module 3-2 and blink judging & mouth open judging module 3-3, the face detecting module 3-1 reads out the digital image from memory circuit and delivers the result into eye & mouth positioning module 3-2 after face positioning; the eye & mouth positioning module 3-2 delivers the result into blink judging & mouth open judging module 3-3 after eye and mouth positioning; the blink judging & mouth open judging module 3-3 sends the judgment result to the controlling circuit 4; at this time, the controlling circuit 4 issues a shoot controlling order when the judgment result received means a best shooting moment, and doesn't issue a shoot controlling order if the judgment result doesn't mean a best shooting moment.

As FIG. 3 shows, the said face detecting module 3-1 includes the multi-dimensioned template 3-1-1, awaiting-taken image 3-1-2 and template matching arithmetic unit 3-1-3, the template matching arithmetic unit receives the multi-dimensioned template 3-1-1 and awaiting-taken image 3-1-2 in memory 2, and delivers the arithmetic result into the face image position 3-1-4, the said multi-dimensioned template 3-1-1, awaiting-taken image 3-1-2 and face image position 3-1-4 are stored at the various address of memory 2 respectively. The multi-dimensioned template is an average face template with 12 kinds of different sizes, it is obtained by plenty of face image's analysis and trainings.

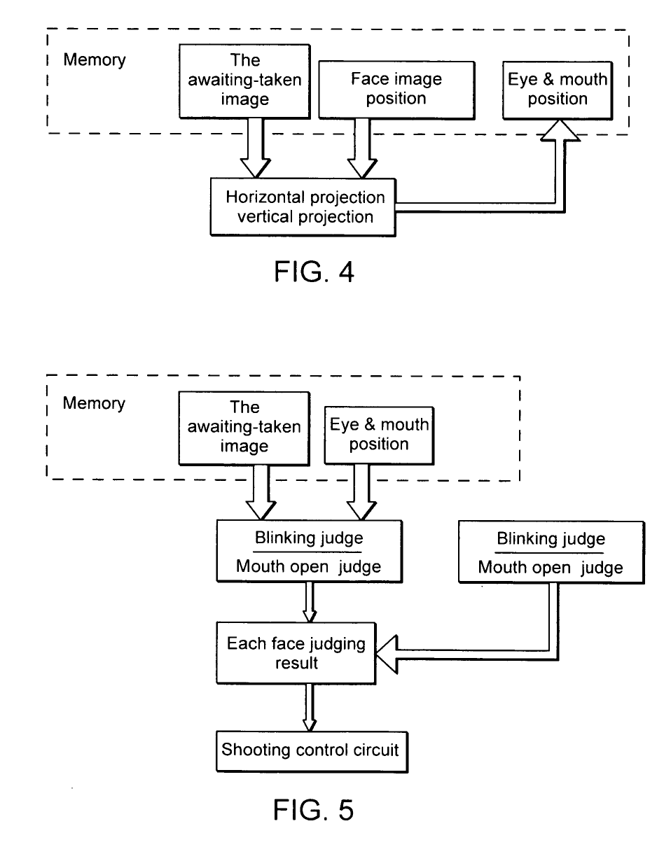

As FIG. 4 shows, the said eye & mouth positioning module 3-2 includes the awaiting-taken image 3-1-2, face image position 3-1-4 and horizontal projecting & vertical projecting unit 3-2-1, the horizontal projecting & vertical projecting unit receives the awaiting-taken image 3-1-2 and face image position 3-1-4 in memory 2, and delivers the arithmetic result into the eye & mouth position 3-2-2, the said awaiting-taken image 3-1-2, face image position 3-1-4 and eye & mouth position 3-2-2 are stored at the various address of memory 2 respectively.

As FIG. 5 shows, the said blink judging & mouth open judging module 3-3 includes the awaiting-taken image 3-1-2, eye & mouth position 3-2-2 and blink judging & mouth open judging unit 3-3-1, the blink judging & mouth open judging unit receives the awaiting-taken image 3-1-2 and eye & mouth position 3-2-2 in memory 2, obtains the blink judging & mouth open judging results for each person face and issues the order to the controlling circuit 4, the said awaiting-taken image 3-1-2 and eye & mouth position 3-2-2 are stored at the various address of memory 2 respectively.

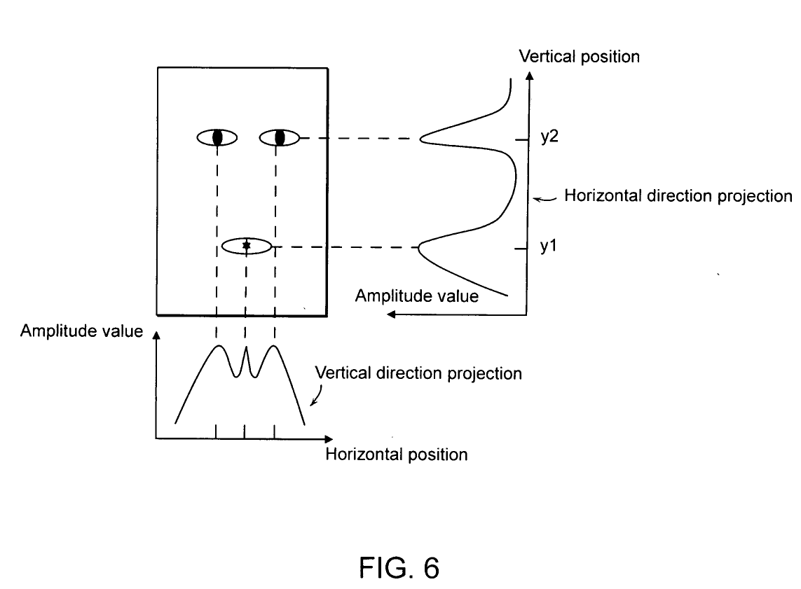

FIG. 6 is a principle block diagram showing the eye & mouth positioning module and blink judging & mouth open judging module, the eye & mouth position is decided conveniently by the projection in horizontal and vertical direction. The blink judging could be made according to if there are three peaks at the corresponding position in the vertical directional projection figure, there would be only one peak in the horizontal directional projection if both eye closed. The mouth open judging could be made according to if the points that are gone from mouth center to top & bottom edges of mouth along the vertical direction have a continuous non-lip color.

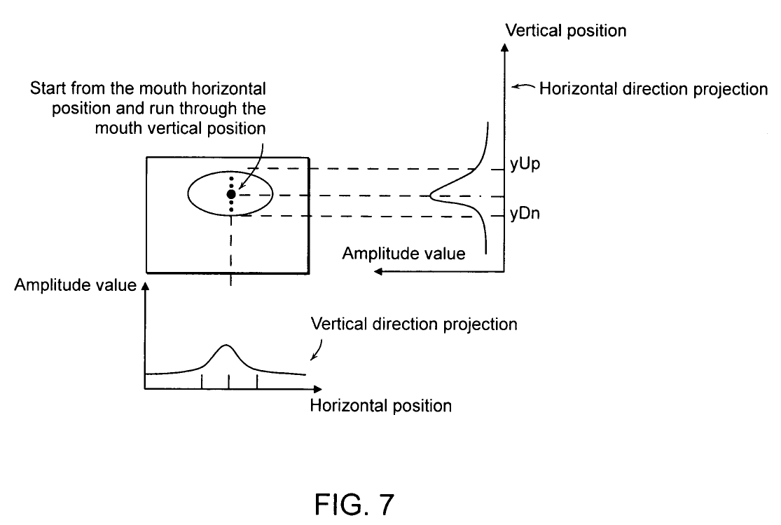

FIG. 7 is a principle block diagram against the mouth open judging, based on the mouth center position obtained from FIG. 6, find out upward the mouth top edge yUp along the vertical direction, and find out downward the mouth bottom edge yDn along the vertical direction, thus obtain the mouth opening (yUp-yDn), compare it with the experience threshold value obtained from statistic and judge if the mouth is open.

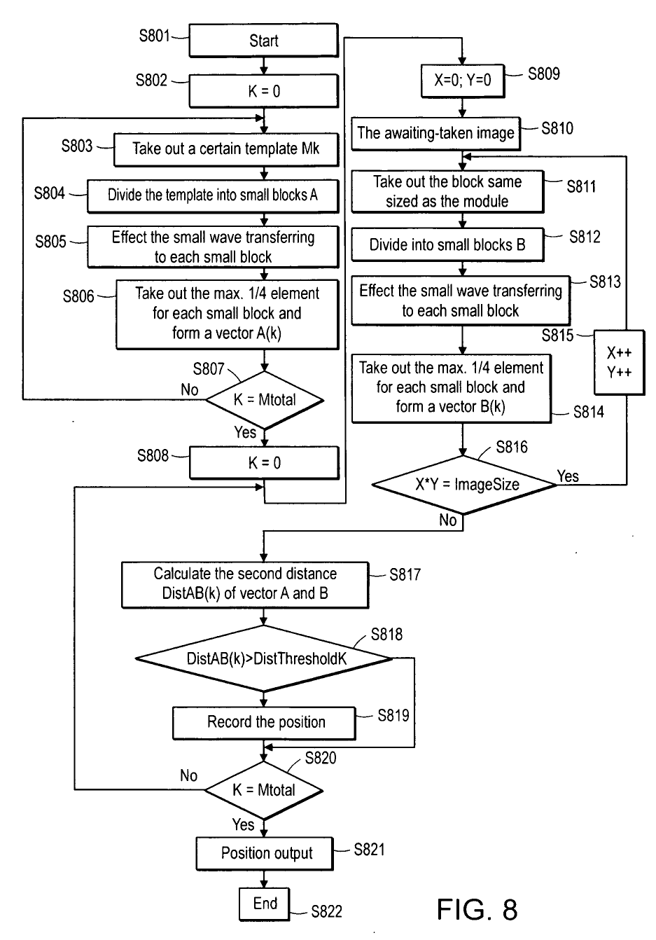

FIG. 8 is a flow chart showing a template matching in face detecting module 3-1:

In S801, start the template matching of face detecting.

In S802, assign K=1. K is the index of template.

In S803, take out a certain template Mk.

In S804, divide the template Mk into N small blocks.

In S805, effect the little wave transferring to each of the small blocks.

In S806, take out the max. ¼ element for each small block and form a vector A(k).

In S807, judge if all the templates are gone through. Enter into S808 if YES, and enter into S803 if NO.

In S808, assign K=1. K is the index of template.

In S809, initialize the X and Y for index the Image.

In S810, read in the awaiting-taken photo Image.

In S811, take out the block S of same sized as the module.

In S812, divide the S into N small blocks.

In S813, effect the little wave transferring to each of the small blocks.

In S814, take out the max. ¼ element for each small block and form a vector B(k).

In S815, increase the deviation of X and Y to make it appoint to the next pixel. If the X is smaller than the image width, increase the X only by one pixel width, if X reaches to the image width, set X to zero and increase Y by a pixel.

In S816, observe if the image edge is reached, enter into S817 if YES and enter into S815 if NO. In S817, calculate the distance DistAB(k) of vector A(k) and B(k).

In S818, observe if the DistAB(k) is more than the threshold DistThreoldK measured from face. Enter into S819 if YES and enter into S820 if NO.

In S819, record the face position.

In S820, confirm if all the templates have been processed, enter into S821 if YES and enter into S809 if NO. In S822, end the process.

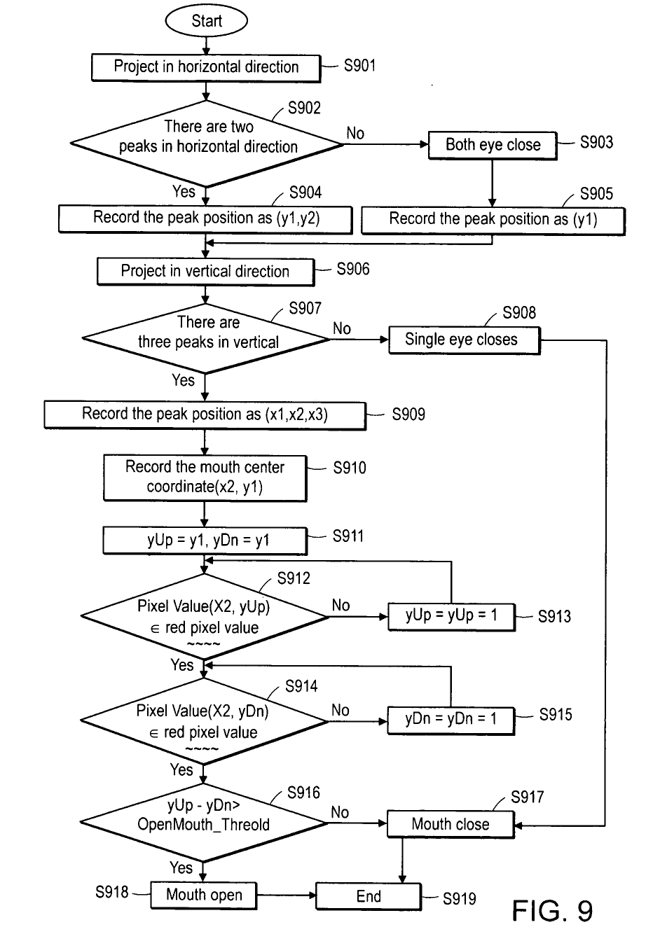

FIG. 9 is a flow chart showing a blink judging & mouth open judging module 3-3:

In S901, project the face image obtained from the face detecting module in the horizontal direction.

In S902, judge that if the image obtained in the last step has two peaks, enter into S904 if YES and enter into S903 if NO.

In S904, record the coordinate position (y1, y2) of the horizontal peak calculated in S902. In fact, the y1 is the projection position along the horizontal direction of the mouth center, and y2 is the projection position along the horizontal direction of the eye center.

In S903, it is concluded that the eyes on face are closed.

In S905, record the peak coordinate position (y1) calculated in S902 and projected in the horizontal direction. In fact, the y1 is the projection position along the horizontal direction of the mouth center.

In S906, project the face image obtained from the face detecting module in the vertical direction.

In S907, judge that if the image obtained in the last step has three peaks, enter into S909 if YES and enter into S908 if NO.

In S909, record the peak coordinate position (x1, x2, x3) calculated in S907 and projected in the vertical direction. In fact, the x1, x2, x3 are respectively the projection position along the vertical direction of the center of right eye, mouth and left eye.

In S910, record the mouth center coordinates (x2, y1).

In S911, initialize the yUp and yDn to the mouth vertical coordinate.

In S912, observe if the pixel value at the coordinates (x2, yUp) is within the lip color area. Enter into S914 if YES and enter into S913 if NO.

In S913, increase the yUp by 1. In fact, it is to increase the vertical coordinate by 1 pixel position.

When search the top edge of lip in S912, S913, the horizontal coordinate x2 is kept invariant, the y2 is increased, the increased y2 is referred to as yUp, and observe if the pixel value at the coordinates (x2, yUp) is within the lip color area.

In S914, observe if the pixel value at the coordinates (x2, yDn) is within the lip color area. Enter into S916 if YES and enter into S915 if NO.

In S915, decrease the yDn by 1. In fact, it is to decrease the vertical coordinate by 1 pixel position.

When search the bottom edge of lip in S914, S915, the horizontal coordinate x2 is kept invariant, the y2 is decreased, the decreased y2 is referred to as yDn, and observe if the pixel value at the coordinates (x2, yDn) is within the lip color area.

In S916, subtract yDn from yUp, and subtract the mouth opening threshold from it. Enter into S918 if it is bigger than the mouth open threshold and enter into S917 if NO.

In S917, judge that the face area image is a closed mouth one.

In S918, judge that the face area image is an opened mouth one.

In S919, end the process.

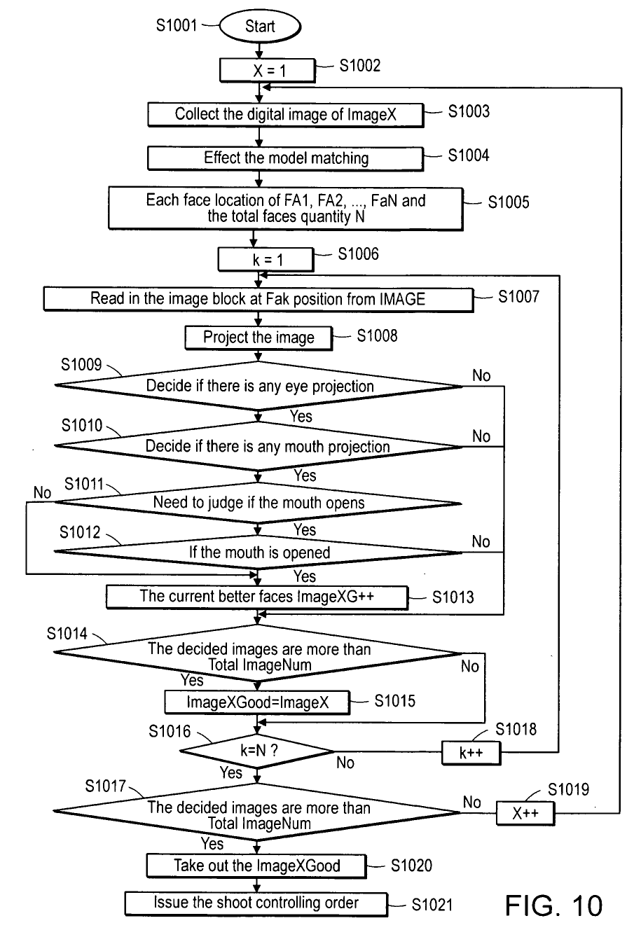

FIG. 10 is a flow chart showing a signal processor 3 in the present invention:

In S1001, start to calculate.

In S1002, assign X=1. X means the image frames to be collected. It is used to decide which frame of the taken image has the best effect.

In S1003, collect the digital image of ImageX.

In S1004, effect the model matching.

In S1005, record each face location of FA1, FA2, . . . , FaN and the total faces quantity N.

In S1006, assign K=1. K means each face position and is for each matched face block.

In S1007, read in the image block at Fak position from ImageX.

In S1008, project the ImageX.

In S1009, decide if there is any eye projection according to the projection image. Enter into S1010 if YES and enter into S1014 if NO.

In S1010, decide if there is any mouth projection according to the projection image. Enter into S1011 if YES and enter into S1014 if NO.

In S1011, decide if need to judge the mouth open. Enter into S1012 if YES and enter into S1013 if NO.

In S1012, decide if the mouth is opened. Enter into S1013 if YES and enter into S1014 if NO.

In S1013, increase the current better faces by 1.

In S1014, decide if the normal bearing faces currently detected in the collected images being more than that of former detected, enter into S1015 if YES and enter into S1016 if NO.

In 1016, decide if all the faces in the current image are processed, enter into S1017 if YES and enter into S1018 if NO.

In S1017, decide if enough frames are processed, enter into S1020 if YES and enter into S1019 if NO.

In S1020, store the best face image frames from the memory.

In S1021, issue the shoot controlling order to complete the following process and the shooting state setting.

We claim:

1. A best shooting moment selectable digital camera apparatus, comprising a camera head (1) and a memory circuit (2), characterized in that: the camera further includes:
Signal processor (3), including co-series face detecting module (3-1), eye & mouth positioning module (3-2) and blink judging & mouth open judging module (3-3), in which:
The face detecting module (3-1) reads out the digital image from memory circuit and delivers the result into eye & mouth positioning module (3-2) after face positioning;
The eye & mouth positioning module (3-2) delivers the result into blink judging & mouth open judging module (3-3) after eye and mouth positioning;
The blink judging & mouth open judging module (3-3) sends out the judgment result;
The controlling circuit (4) issues a shoot controlling order when the judgment result of the said blink judging & mouth open judging module (3-3) means a best shooting moment, and doesn't issue a shoot controlling order if the judgment result doesn't mean a best shooting moment.

2. The best shooting moment selectable digital camera apparatus according to claim 1, characterized in that: the said face detecting module (3-1) includes the multi-dimensioned template (3-1-1), awaiting-taken image (3-1-2) and template matching arithmetic unit (3-1-3), the template matching arithmetic unit receives the multi-dimensioned template (3-1-1) and awaiting-taken image (3-1-2) in memory (2), and delivers the arithmetic result into the face image position (3-1-4), the said multi-dimensioned template (3-1-1), awaiting-taken image (3-1-2) and face image position (3-1-4) are stored at the various address of memory (2) respectively.

3. The best shooting moment selectable digital camera apparatus according to claim 1, characterized in that: the said eye & mouth positioning module (3-2) includes the awaiting-taken image (3-1-2), face image position (3-1-4) and horizontal projecting & vertical projecting unit (3-2-1), the horizontal projecting & vertical projecting unit receives the awaiting-taken image (3-1-2) and face image position (3-1-4) in memory (2), and delivers the arithmetic result into the eye & mouth position (3-2-2), the said awaiting-taken image (3-1-2), face image position (3-1-4) and eye & mouth position (3-2-2) are stored at the various address of memory (2) respectively.

4. The best shooting moment selectable digital camera apparatus according to claim 1, characterized in that: the said blink judging & mouth open judging module (3-3) includes the awaiting-taken image (3-1-2), eye & mouth position (3-2-2) and blink judging & mouth open judging unit (3-3-1), the blink judging & mouth open judging unit receives the awaiting-taken image (3-1-2) and eye & mouth position (3-2-2) in memory (2), obtains the blink judging & mouth open judging results for each person face and issues the order to the controlling circuit (4), the said awaiting-taken image (3-1-2) and eye & mouth position (3-2-2) are stored at the various address of memory (2) respectively.
